(19) United States
(12) Patent Application Publication
(10) Pub. No.: US 2026/0350171 A1
(43) Pub. Date: Nov. 5, 2026

(54) ELECTRONIC CONTROL UNIT FOR A VEHICLE COMPRISING A HARDWARE SECURITY MODULE, AND METHOD OF OPERATION OF SUCH AN ELECTRONIC CONTROL UNIT

(71) Applicant: SCHAEFFLER TECHNOLOGYIES AG & CO. KG, Herzogenaurach (DE)

(72) Inventors: Nicolas MINIER, Lacourt-Saint-Pierre (FR); Pierre BOUCHER, Toulouse (FR); Yohann CHEVALIER, Plaisance du touch (FR)

(73) Assignee: SCHAEFFLER TECHNOLOGYIES AG & CO. KG, Herzogenaurach (DE)

(21) Appl. No.: 19/125,467

(22) PCT Filed: Dec. 5, 2023
(86) PCT No.: PCT/EP2023/084215

§ 371 Date: Apr. 29, 2025

(30) Foreign Application Priority Data
Dec. 8, 2022 (FR) FR2212981

(51) Int. Cl. G06F 21/57; G06F 21/44

(52) U.S. Cl. CPC G06F 21/575; G06F 21/44; G06F 2221/033

(57) ABSTRACT

The invention relates to an electronic control unit for a vehicle. The electronic control unit including a main processor, a memory, a hardware security module and a plurality of application cores. The memory storing a boot loader and application code. The hardware security module includes a trust anchor and a memory. The memory of the hardware security module storing rescue computer code configured to implement at least one diagnostic function of the electronic control unit when it is executed by the main processor, and the trust anchor being configured to verify the integrity and authenticate the boot loader within the plurality of application cores.

### CROSS REFERENCE TO RELATED APPLICATIONS

This application is the U.S. National Phase Application of PCT International Application No. PCT/EP2023/084215, filed Dec. 5, 2023, which claims priority to French Patent Application No. FR2212981, filed Dec. 8, 2022, the contents of such applications being incorporated by reference herein.

### FIELD OF THE INVENTION

The invention relates to an electronic control unit for a vehicle, notably a motor vehicle, comprising a main processor, memory means, a hardware security module and a plurality of application cores. The invention lies in the field of electronic and computer security, and more specifically of the secure start-up of an electronic control unit on board a vehicle and of the execution of authentic application code on such an electronic control unit. The invention also relates to a method of operation of such an electronic control unit, as well as to a computer program product for implementing certain steps of this method. The electronic control unit is, for example, a microcontroller, without this being limiting in the context of the present invention.

### BACKGROUND OF THE INVENTION

Electronic control units for a vehicle, notably a motor vehicle, typically comprising a main processor, memory means, a hardware security module and several application cores are known from the prior art. Such an electronic control unit (ECU) is, for example, a microcontroller. The memory means are connected to the main processor via a data communication bus and store a boot loader and application code intended to be executed by the main processor (such application code being, for example, intended to make it possible to control software components of the vehicle such as those belonging notably to engine control or else to the electrical storage battery). The boot loader corresponds to a software layer other than the application code and comprises several boot sequences. The boot loader is configured, when executed by the main processor, to request verification of the integrity and authentication of the application code stored in the memory means and to execute this application code on the application cores when the application code has been authenticated. The hardware security module (HSM) includes a trust anchor and a memory. The trust anchor is the only element of the electronic control unit which the latter trusts immutably. The trust anchor is connected to the main processor via the data communication bus and is configured to verify the integrity and authenticate the application code stored in the memory means, as well as to authorize the execution of the application code on the application cores. The trust anchor is thus responsible for performing security functions within the electronic control unit, and is more generally part of a mechanism referred to as the “secure boot” mechanism, which comprises a series of levels, each level involving the execution of a new piece of computer code after necessary verifications of the integrity of the code and optional decryption of the protected content, the trust anchor corresponding to the first level. Indeed, vehicle manufacturers and users are now asking to be assured that the application code executed by a dedicated electronic control unit in the vehicle is sufficiently secure to be executed. “Sufficiently secure” means that the unit is in a mode which is secure to be executed but also in a state where it is guaranteed that no one has been able to modify the contents of the non-volatile internal memory of the unit, dedicated to storing the software making it possible to have an operational system being executed. The hardware security module, and therefore the trust anchor, is the first module executed by the electronic control unit and is responsible for authorizing the boot loader to execute the application code on the application cores.

However, when one of the boot sequences of the boot loader is no longer trustworthy (and therefore no longer authenticatable), the latter cannot be executed by the main processor of the electronic control unit. The application code then becomes in turn unexecutable within the unit, the latter becoming inoperative in the vehicle without the end user of the vehicle understanding the reason for this. Indeed, in the systems currently used the electronic control unit does not offer any means for the user to communicate with it in order to understand the reason for which the boot loader and the application code are no longer being executed within the system and/or to attempt to update the application code within the unit. In particular, the user has no diagnostic means to distinguish between a hardware memory problem (in particular on the memory means) and a malicious attack (of intentional compromise type) on the unit.

An aim of an aspect of the invention is to mitigate the drawbacks of the prior art by proposing an electronic control unit for a vehicle, notably a motor vehicle, which offers the opportunity to a user or to a manufacturer of the vehicle to understand the reason for which the boot loader and the application code are no longer being executed within the system, while at the same time making it possible for the electronic control unit to continue to be executed in a dedicated mode in order to offer a means for communication and for diagnosis with the outside.

### SUMMARY OF THE INVENTION

To this end, an aspect of the invention thus relates, in its broadest sense, to an electronic control unit for a vehicle, the electronic control unit comprising a main processor, memory means, a hardware security module and a plurality of application cores, the memory means being connected to the main processor via a data communication bus and storing a boot loader and application code intended to be executed by the main processor on the plurality of application cores, said boot loader comprising several boot sequences and being configured, when executed by the main processor, to request verification of the integrity and authentication of the application code stored in the memory means and to execute said application code on the plurality of application cores when said application code has been authenticated, the hardware security module comprising a trust anchor and a memory, the trust anchor being connected to the main processor and to the memory means via the data communication bus and being configured to verify the integrity and authenticate the application code stored in the memory means and to authorize the execution of said application code on the plurality of application cores, the application cores being connected to the main processor via the data communication bus, the memory of the hardware security module storing rescue computer code, said rescue computer code being intended to be executed by the main processor, on the plurality of application cores, and being configured to implement at least one diagnostic function of the electronic control unit when it is executed by the main processor, and in that the trust anchor is further configured to verify the integrity and authenticate the boot loader within the plurality of application cores and, if the boot loader is not authenticated, to download the rescue computer code from the memory of the hardware security module to the memory means, to install said rescue computer code in place of a first boot sequence of the boot loader and to have the main processor execute said rescue computer code on the plurality of application cores.

By virtue of the presence, in the memory of the hardware security module, of the rescue computer code thus configured, the electronic control unit for a vehicle according to an aspect of the invention offers the opportunity to a user or to a manufacturer of the vehicle to understand the reason for which the boot loader and the application code are no longer being executed within the system, while at the same time making it possible for the electronic control unit to continue to be executed in a dedicated mode in order to offer a means for communication and for diagnosis with the outside. Such a diagnostic means directly on board the electronic control unit advantageously makes it possible to reduce the costs as well as the time for diagnosing and dealing with a possible hardware failure or with a malicious intrusion into the system, as well as to avoid having to dispose of the unit when the cause of the non-authentication of the boot loader is unknown.

According to one particular technical feature of an aspect of the invention, the memory of the hardware security module is a non-volatile memory, preferably a flash memory. Such a non-volatile memory is read and write accessible only to the trust anchor, this making it possible to improve the security of the electronic control unit, in particular in relation to the use and authentication of the rescue computer code.

According to another particular technical feature of an aspect of the invention, the memory means comprise a non-volatile memory, preferably a flash memory.

According to another particular technical feature of an aspect of the invention, the data communication bus is a CAN (controller area network) bus or a bus in accordance with the Ethernet protocol.

Advantageously, a compressed image of the rescue computer code is stored in the memory of the hardware security module. This makes it possible to optimize the consumption of memory resources within the hardware security module.

Advantageously, the rescue computer code is stored in an application portion of the memory of the hardware security module. This makes it possible to make it easier for an end user of the electronic control unit or for a manufacturer of the vehicle to update the rescue computer code.

Advantageously, the trust anchor is further configured to verify the integrity and authenticate the rescue computer code. This makes it possible to further improve the security associated with the use of the rescue computer code within the electronic control unit.

According to one particular technical feature of an aspect of the invention, the trust anchor is further configured to execute an instruction to reset the electronic control unit.

Advantageously, the rescue computer code is further configured, when executed by the main processor, to implement a function of uploading the application code from the memory means to a memory of a third-party device connected to the electronic control unit. This makes it possible for a user of the third-party device to be able to retrieve the possibly compromised application code. The memory of such a third-party device is, for example, a block of random-access memory or indeed a non-volatile storage device of flash memory type. Advantageously, the rescue computer code is configured so as to be able to verify the integrity and authenticity of the application code uploaded to the memory of the third-party device.

An aspect of the invention also relates to a method of operation of an electronic control unit for a vehicle as described above, the method comprising the following steps:
the trust anchor verifying the integrity of the boot loader within the plurality of application cores;
if the verification of the integrity of the boot loader within the plurality of application cores is positive, the trust anchor authenticating the boot loader and:
   the boot loader sending the trust anchor a request to verify the integrity and to authenticate the application code stored in the memory means;
   the trust anchor verifying the integrity and authenticating the application code stored in the memory means;
   the trust anchor authorizing the execution of said application code on the plurality of application cores; and
   the main processor executing, via the boot loader, said application code on the plurality of application cores;
if the verification of the integrity of the boot loader within the plurality of application cores is negative:
   the trust anchor downloading the rescue computer code from the memory of the hardware security module to the memory means;
   the trust anchor installing said rescue computer code in place of a first boot sequence of the boot loader; and
   the main processor executing said rescue computer code on the plurality of application cores.

Advantageously, if the verification of the integrity of the boot loader within the plurality of application cores is negative, the method further comprises a step of the trust anchor verifying the integrity and authenticating the rescue computer code. This makes it possible to further improve the security associated with the use of the rescue computer code within the electronic control unit.

According to one particular technical feature of an aspect of the invention, if the verification of the integrity of the boot loader within the plurality of application cores is negative, the method further comprises a step of the trust anchor executing an instruction to reset the electronic control unit. After this reset, the electronic control unit is now able to communicate only with the outside, in order to offer a user or a manufacturer of the vehicle a means for communication and for diagnosis by virtue of the execution of the rescue computer code.

According to one particular variant embodiment of the invention, the step of the trust anchor verifying the integrity of the boot loader within the plurality of application cores comprises verifying the integrity of the first boot sequence of the boot loader within the plurality of application cores, and verifying the integrity of a flash boot loader module within the plurality of application cores, the verification of the integrity of the boot loader within the plurality of application cores being positive if and only if the results of said two verifications are positive.

An aspect of the invention also relates to a computer program product comprising a set of program code instructions which, when they are executed by a processor, configure the processor to implement one or more steps of the method as described above, said computer program product constituting the rescue computer code, said processor being the main processor.

### BRIEF DESCRIPTION OF THE DRAWINGS

Embodiments of the present invention will be described below by way of non-limiting examples, with reference to the appended figures, in which:

FIG. 1 is a schematic depiction of an electronic control unit for a vehicle according to an aspect of the present invention; and

FIG. 2 is a flowchart illustrating the method of operation of the electronic control unit of FIG. 1.

### DETAILED DESCRIPTION OF EXEMPLARY EMBODIMENTS

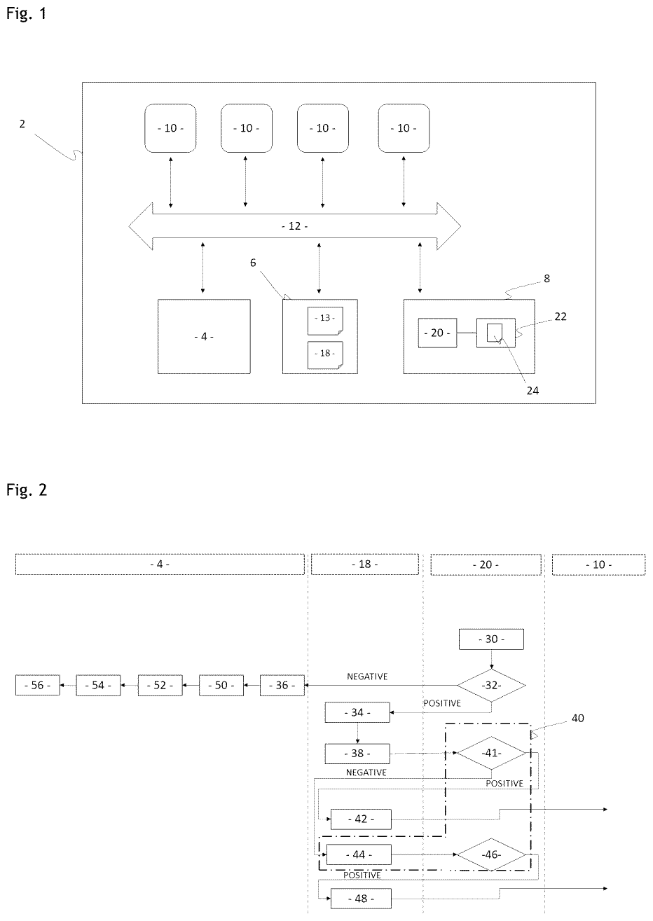

With reference to FIG. 1, an electronic control unit 2 according to one embodiment of the invention is illustrated. The electronic control unit 2 is installed within a vehicle, notably a motor vehicle (such a vehicle not being depicted in the figures for reasons of clarity), it is, for example, intended to control certain physical elements of the vehicle such as, notably, engine control or indeed an electrical storage battery. The electronic control unit 2 is, for example, a microcontroller implanted on a single chip, without this being limiting in the context of the present invention.

The electronic control unit 2 comprises a main processor 4, memory means 6, a hardware security module 8 and several application cores 10. The computer system 2 also comprises a data communication bus 12 connecting these various elements. The memory means 6 are connected to the main processor 4 via the data communication bus 12, and store application code 13 intended to be executed by the main processor 4, on the application cores 10, in order notably to make it possible to control certain software components belonging to the various physical elements of the vehicle which are mentioned above. The memory means 6 also store a boot loader 18, for example on an area or partition which is different from that used for storing the application code 13. The memory means 6 typically comprise a non-volatile memory, preferably a flash memory, in which the application code 13 and the boot loader 18 are stored (under partitions and/or in different layers).

The boot loader 18 is in the form of program code, in other words a series of computer instructions intended to be executed by the main processor 4. More specifically, the boot loader 18 corresponds to a software layer other than the application code 13, comprises several boot sequences and is configured, when it is executed by the main processor 4, to request verification of the integrity and authentication of the application code 13, and to execute the application code 13 on the application cores 10 when the application code 13 has been authenticated.

The hardware security module 8 comprises a trust anchor 20 and a memory 22 which stores a rescue computer code 24. The trust anchor 20 is connected to the main processor 4 and to the memory means 6 via the data communication bus 12. The trust anchor 20 is configured to verify the integrity and authenticate the application code 13 stored in the memory means 6, and to authorize the execution of the application code 13 on the application cores 10. As will be detailed below, the trust anchor 20 is further configured to verify the integrity and authenticate the boot loader 18 within the application cores 10 and, if the boot loader 18 is not authenticated, to download the rescue computer code 24 from the memory 22 of the hardware security module 8 to the memory means 6, to install the rescue computer code 24 in place of a first boot sequence of the boot loader 18 and to have the main processor 4 execute the rescue computer code 24 on the application cores 10. Preferably, the trust anchor 20 is also configured to verify the integrity and authenticate the rescue computer code 24. Also preferably, the trust anchor 20 is also configured to execute an instruction to reset the electronic control unit 2.

The memory 22 of the hardware security module 8 is typically a non-volatile memory, preferably a flash memory. The rescue computer code 24 is intended to be executed by the main processor 4, on the application cores 10, and is configured to implement at least one diagnostic function of the electronic control unit 2 when it is executed by the main processor 4. Preferably, in addition to the diagnostic function of the electronic control unit 2, the rescue computer code 24 is additionally configured, when executed by the main processor 4, to implement a function of uploading the application code 13 from the memory means 6 to a memory of a third-party device connected to the computer system 2 (such a third-party device not being depicted in FIG. 1 for reasons of clarity). Also preferably, a compressed image of the rescue computer code 24 is stored in the memory 22 of the hardware security module 8. Also preferably, the rescue computer code 24 is stored in an application portion of the memory 22 of the hardware security module 8.

The data communication bus 12 is typically a CAN (controller area network) bus or a bus in accordance with the Ethernet protocol, without this being limiting in the context of the present invention.

The method of operation of the electronic control unit 2 according to one embodiment of the invention will now be described with reference to FIG. 2.

The method comprises an initial step 30 during which the hardware security module 8 is initialized by the main processor 4.

The method comprises a following step 32 during which the trust anchor 20 verifies the integrity of the boot loader 18 within the application cores 10. Preferably, the verifying 32 of the integrity of the boot loader 18 within the application cores 10 comprises verifying the integrity of a first boot sequence of the boot loader 18 within the application cores 10, and verifying the integrity of a flash boot loader module within the application cores 10.

If the verification 32 of the integrity of the boot loader 18 within the application cores 10 is positive (in other words, if and only if the results of the two verifications mentioned above are positive), the trust anchor 20 authenticates the boot loader 18 and the method moves to a following step 34. Otherwise (in other words, if at least one of the two verifications mentioned above is negative), the trust anchor 20 does not authenticate the boot loader 18 and the method moves to a following step 36.

During the step 34, the main processor 4 initializes the boot loader 18. The method then comprises a following step 38, during which the boot loader 18 sends the trust anchor 20 a request to verify the integrity and to authenticate the application code 13 stored in the memory means 6.

During a step 40 following the step 38, the trust anchor 20 verifies the integrity of the application code 13 stored in the memory means 6. In the particular example of an embodiment of FIG. 2, the application code 13 is divided into a high-level application code and an application code for reprogramming the high-level application code. According to this particular example of an embodiment, the step 40 therefore begins with a phase 41 of verifying the integrity of the high-level application code stored in the memory means 6.

If the phase 41 of verifying the integrity of the high-level application code is positive, the trust anchor 20 authenticates the high-level application code and authorizes the execution of the high-level application code on the application cores 10, and the method moves to a following step 42. Otherwise, the trust anchor 20 does not authenticate the high-level application code and the method moves to a following phase 44.

During the step 42, the main processor 4 executes, via the boot loader 18, the high-level application code on the application cores 10.

During the phase 44, the boot loader 18 sends the trust anchor 20 a request to verify the integrity and to authenticate the reprogramming application code stored in the memory means 6.

During a phase 46 following the phase 44, the trust anchor 20 verifies the integrity of the reprogramming application code stored in the memory means 6.

If the verification 46 of the integrity of the reprogramming application code is positive, the trust anchor 20 authenticates the reprogramming application code and authorizes the execution of the reprogramming application code on the application cores 10, and the method moves to a following step 48. Otherwise, the trust anchor 20 does not authenticate the reprogramming application code and does not authorize the execution of the reprogramming application code on the application cores 10. During the step 48, the main processor 4 executes, via the boot loader 18, the reprogramming application code on the application cores 10.

During the step 36, the trust anchor 20 downloads the rescue computer code 24 from the memory 22 of the hardware security module 8 to the memory means 6.

Preferably, during a step 50 following the step 36, the trust anchor 20 verifies the integrity of the rescue computer code 24, and authenticates, where applicable, the rescue computer code 24.

During a step 52 following the step 50, the trust anchor 20 installs the rescue computer code 24 in place of a first boot sequence of the boot loader 18.

Preferably, during a step 54 following the step 52, the trust anchor 20 executes an instruction to reset the electronic control unit 2.

During a step 56 following the step 54, the main processor 4 restarts under an authenticity session and executes the rescue computer code 24 on the application cores 10. The execution of the rescue computer code 24 on the application cores 10 then makes it possible to implement at least one diagnostic function, in order to be able to communicate with the outside of the electronic control unit 2 and to make it possible for a user of the unit 2 or for a manufacturer of the vehicle to understand the reason for which the boot loader 18 and the application code 13 are no longer being executed within the system and/or try to update the application code 13 within the unit 2. According to one particular embodiment of the invention, the execution of the rescue computer code 24 on the application cores 10 may also make it possible to upload the application code 13 from the memory means 6 to a memory of a third-party device connected to the electronic control unit 2 (such a third-party device not being depicted in the figures for reasons of clarity). According to this embodiment, the third-party device is, for example, a block of random-access memory or indeed a non-volatile storage device of flash memory type. The rescue computer code 24 may, for example, be configured to be able to verify the integrity and authenticate the application code 13 uploaded to the memory of the third-party device.

The electronic control unit 2 for a vehicle according to an aspect of the invention offers the opportunity to a user or to a manufacturer of the vehicle to understand the reason for which the boot loader and the application code are no longer being executed within the system, while at the same time making it possible for the electronic control unit to continue to be executed in a dedicated mode in order to offer a means for communication and for diagnosis with the outside.

1. An electronic control unit for a vehicle, the electronic control unit comprising:
a main processor,
a memory,
a hardware security module and a plurality of application cores the memory being connected to the main processor via a data communication bus and storing a boot loader and application code intended to be executed by the main processor, on the plurality of application cores,
said boot loader comprising several boot sequences and being configured, when executed by the main processor, to request verification of the integrity and authentication of the application code stored in the memory and to execute said application code on the plurality of application cores when said application code has been authenticated,
the hardware security module comprising a trust anchor and a memory, the trust anchor being connected to the main processor and to the memory means via the data communication bus and being configured to verify the integrity and authenticate the application code stored in the memory and to authorize the execution of said application code on the plurality of application cores,
the application cores being connected to the main processor via the data communication bus,
wherein the memory of the hardware security module stores rescue computer code, said rescue computer code being intended to be executed by the main processor on the plurality of application cores and being configured to implement at least one diagnostic function of the electronic control unit when it is executed by the main processor, and the trust anchor is further configured to verify the integrity and authenticate the boot loader within the plurality of application cores and, if the boot loader is not authenticated, to download the rescue computer code from the memory of the hardware security module to the memory, to install said rescue computer code in place of a first boot sequence of the boot loader and have the main processor execute said rescue computer code on the plurality of application cores.

2. The electronic control unit as claimed in claim 1, wherein the memory of the hardware security module is a non-volatile memory.

3. The electronic control unit as claimed in claim 1, wherein a compressed image of the rescue computer code is stored in the memory of the hardware security module.

4. The electronic control unit as claimed in claim 1, wherein the rescue computer code is stored in an application portion of the memory of the hardware security module.

5. The electronic control unit as claimed in claim 1, wherein the trust anchor is further configured to verify the integrity and authenticate the rescue computer code.

6. The electronic control unit as claimed in claim 1, wherein the trust anchor is further configured to execute an instruction to reset the electronic control unit.

7. The electronic control unit as claimed in claim 1, wherein the rescue computer code is further configured, when executed by the main processor, to implement a function of uploading the application code from the memory to a memory of a third-party device connected to the electronic control unit.

8. A method of operation of an electronic control unit for a vehicle as claimed in claim 1, wherein the method comprises:
the trust anchor verifying the integrity of the boot loader within the plurality of application cores;
if the verification of the integrity of the boot loader within the plurality of application cores is positive, the trust anchor authenticating the boot loader and:
the boot loader sending the trust anchor a request to verify the integrity and to authenticate the application code stored in the memory;
the trust anchor verifying the integrity and authenticating the application code stored in the memory means;
the trust anchor authorizing the execution of said application code on the plurality of application cores; and
the main processor executing via the boot loader said application code on the plurality of application cores;
if the verification of the integrity of the boot loader within the plurality of application cores is negative:
the trust anchor downloading the rescue computer code from the memory of the hardware security module to the memory;
the trust anchor installing said rescue computer code in place of a first boot sequence of the boot loader; and
the main processor executing said rescue computer code on the plurality of application cores.

9. The method as claimed in claim 8, wherein, if the verification of the integrity of the boot loader within the plurality of application cores is negative, the method further comprises a step of the trust anchor verifying the integrity and authenticating the rescue computer code.

10. The method as claimed in claim 8, wherein, if the verification of the integrity of the boot loader within the plurality of application cores is negative, the method further comprises a step of the trust anchor executing an instruction to reset the electronic control unit.

11. The method as claimed in claim 8, wherein the step of the trust anchor verifying the integrity of the boot loader within the plurality of application cores comprises verifying the integrity of the first boot sequence of the boot loader within the plurality of application cores, and verifying the integrity of a flash boot loader module within the plurality of application cores, the verification of the integrity of the boot loader within the plurality of application cores being positive if and only if the results of said two verifications are positive.

12. A non-transitory computer program product comprising a set of program code instructions which, when they are executed by a processor, configure the processor to implement one or more steps of the method as claimed in claim 8, said computer program product constituting the rescue computer code, said processor being the main processor.

13. The electronic control unit as claimed in claim 1, wherein the memory of the hardware security module is a flash memory.

14. The electronic control unit as claimed in claim 2, wherein a compressed image of the rescue computer code is stored in the memory of the hardware security module.

15. The method as claimed in claim 9, wherein, if the verification of the integrity of the boot loader within the plurality of application cores is negative, the method further comprises a step of the trust anchor executing an instruction to reset the electronic control unit.
